(19) United States
(12) Patent Application Publication
(10) Pub. No.: US 2009/0132847 A1
(43) Pub. Date: May 21, 2009

(54) Information processing apparatus having memory clock setting function and memory clock setting method

(75) Inventor: Takayoshi Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,411

(22) Filed: Aug. 28, 2008

(30) Foreign Application Priority Data
Nov. 21, 2007 (JP) 2007-301663

(51) Int. Cl. G06F 1/08

(52) U.S. Cl. 713/600

(57) ABSTRACT

A memory clock setting function acquires the band of a memory bus, and acquires the total band of a CPU bus and the I/O buses. When the band of the memory bus is greater than the total band of the CPU bus and I/O buses, the clock rate less than or equal to the current operation clock of a memory is selected so that the band of the memory bus may not be less than the total band of the CPU bus and the I/O buses, and the selected clock rate is set as the operation clock of the memory to a memory controller.

### CROSS-REFERENCE TO RELATED APPLICATIONS

This application claims the conventional priority based on Japanese Patent Application No. 2007-301663, filed on Nov. 21, 2007, the disclosures of which are incorporated herein by reference.

### BACKGROUND OF THE INVENTION

1. Field of the Invention

An embodiment of the present invention relates to a technique for setting an operation clock of a memory, which may include an information processing apparatus having a memory clock setting function for changing a set of the operation clock of the memory according to a band of a bus other than a memory bus connected to a memory controller and a memory clock setting method.

2. Description of the Related Art

FIG. 5 is a diagram for explaining an example of the peripheral environment of a memory. In FIG. 5, a bus connecting a CPU 500 and a memory controller 510 is called a CPU bus 600, a bus connecting an I/O bridge 530 and the memory controller 510 is called an I/O bus 610, and a bus connecting the memory controller 510 and a memory 520 is called a memory bus 620. The I/O bus 610 is used by the I/O devices such as a graphic device, a hard disk drive and an optical drive, which are connected to the I/O bridge 530.

There is a possibility that both of an access from the CPU 500 to the memory 520 and an access from the I/O to the memory 520 may occur at the same time. Accordingly, a band of the memory bus 620 is desirably equal to or greater than a total band of buses connected to the memory controller 510 other than the memory bus (the CPU bus 600 and the I/O bus 610 in an example of FIG. 5).

In recent years, a technique for greatly increasing a memory data transfer rate by expanding the band of the memory bus 620 has been provided. For example, there is a dual channel technique for increasing the memory data transfer rate by using two memory at the same time, each of which has the same capacity.

With such techniques, there is possibility that a transfer rate of the memory bus 620 greatly exceeds a total band of the other buses connected to the memory controller 510 (the CPU bus 600 and the I/O bus 610 in the example of FIG. 5). In such a case, the band of the other buses connected to the memory controller 510 becomes a bottleneck, which makes it impossible to make the full use of the increased memory data transfer rate.

On the other hand, the memory operation speed (clock speed) has also increased but becomes one of the causes of increasing the power consumption of the memory 520.

The related arts concerning a control of the operation clock in the memory are described in Japanese Patent Laid-Open No. 2000-187525, Japanese Patent Laid-Open No. 10-21135, and Japanese Patent Laid-Open No. 2001-117815, for example.

Japanese Patent Laid-Open No. 2000-187525 described a technique for stopping the memory clock not used when the memory is not mounted, or the memory clock not used depending on a kind of a mounted memory. This technique is planned as the countermeasure against electromagnetic interference (EMI).

Japanese Patent Laid-Open No. 10-21135 described a technique for detecting the fastest settings in which a data error does not occur, when data is actually written and read while changing the settings of the memory, without depending on the operation specifications of the memory itself decided by the memory vendor. This technique is needed when the band of the memory bus is smaller than the other buses.

Japanese Patent Laid-Open No. 2001-117815 described a technique for raising the alert, when a memory with an operation frequency not guaranteed by the system is mounted, or when memories with multiple operation frequencies are mingled and mounted.

Thus described, in the recent system, even when the memory data transfer rate is increased, the increased transfer rate can not be fully exhibited since the other part may become the bottleneck, and a problem is caused that the power consumption of the memory is increased due to the increased transfer rate.

### SUMMARY OF THE INVENTION

One aspect of an object of the present invention is to solve the above-mentioned problem, and to provide a technique for reducing a power consumption of a memory as much as possible while making the best use of an increased memory data transfer rate.

In order to accomplish the above object, according to an embodiment of the present invention, when a band of a memory bus is greater than a total band of the other buses connected to a memory controller, a set of an operation clock of a memory is changed so that the band of the memory bus may be a value as close to the total band of the other buses as possible.

The band of the memory bus and the total band of the other buses connected to the memory controller are acquired. For the band of the memory bus, its theoretical value can be calculated from the clock rate set as the operation clock of the memory in the memory controller. For the band of the other buses, the theoretical value can be calculated from the setting of each controller or bridge, or the information may be stored in a ROM on the I/O bridge when the bus band is known in advance, whereby the bus band information can be acquired from the ROM.

The obtained band of the memory bus and the total band of the other buses connected to the memory controller are compared. When the band of the memory bus is greater than the total band of the other buses connected to the memory controller, a set of an operation clock of the memory is decreased in the range where the band of the memory bus is not less than the total band of the other buses connected to the memory controller.

The information processing apparatus of an embodiment of the present invention includes a memory, a memory controller controlling the memory, and a memory clock setting function for changing a set of an operation clock of the memory. And, the apparatus includes a first acquiring unit acquiring a band of a memory bus connecting the memory controller and the memory, a second acquiring unit acquiring a band of other buses connected to the memory controller except for the memory bus, a comparing unit comparing a total band of the other buses connected to the memory controller except for the memory bus and the band of the memory bus, and a changing unit changing, when the band of the memory bus is greater than the total band of the other buses connected to the memory controller except for the memory bus, the set of the operation clock of the memory by making the operation clock of the memory slower than current operation clock in a range where the band of the memory bus is not less than the total band of the other buses connected to the memory controller except for the memory bus.

In the information processing apparatus, the band of the memory bus is calculated based on a clock rate of the operation clock of the memory set in the memory controller or a clock rate settable as the operation clock of the memory.

Also, a processing for changing the set of the operation clock of the memory is performed, when starting the information processing apparatus, by a control program of a basic input/output system stored in a basic input/output system storage memory provided for the information processing apparatus.

In this way, by decreasing the operation clock of the memory in necessary and sufficient manner, the power consumption of the memory can be reduced with the same logical performance as the maximal operation clock of the memory is set.

According to the embodiment of the present invention, the operation clock of the memory can be decreased so that the band of the memory bus may be necessary and sufficient according to the total band of the other buses connected to the memory controller except for the memory bus. As a result, the power consumption of the memory can be reduced with the same logical performance as the maximal operation clock of the memory is set.

### BRIEF DESCRIPTION OF THE DRAWINGS

FIG. 1 is a diagram showing a configuration example of an information processing apparatus according to an embodiment of the present invention.

FIG. 2 is a diagram showing a configuration example of a memory clock setting function.

FIG. 3 is a flowchart of a memory clock setting processing with the memory clock setting function.

FIG. 4 is a view showing the current consumption in reading memory data from a typical memory (1 GB, DDR2, rating 800 MHz).

FIG. 5 is a diagram for explaining an example of the peripheral environment of the memory.

### DETAILED DESCRIPTION OF THE PREFERRED EMBODIMENTS

The embodiments of the present invention will be described below with reference to the drawings.

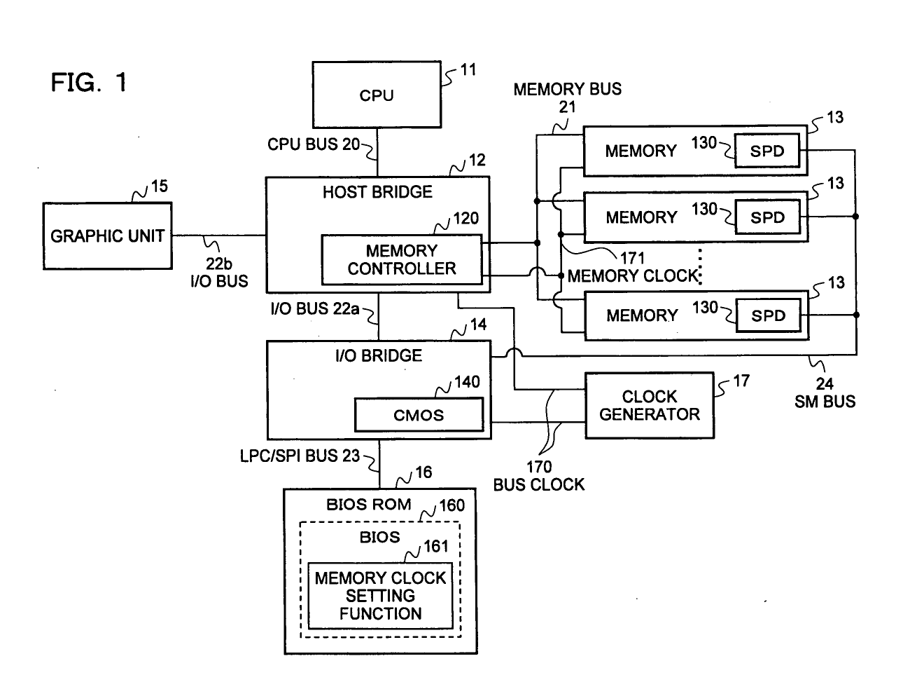

FIG. 1 is a diagram showing a configuration example of an information processing apparatus according to an embodiment of the present invention. The information processing apparatus includes a CPU 11, a host bridge 12, a memory 13, an I/O bridge 14, a graphic unit 15, a BIOS ROM 16 and a clock generator 17.

The CPU 11 is a processor which controls the system or apparatus.

The host bridge 12 is a chip which connects the CPU 11, the memory 13 and the I/O, and may include a memory controller 120 depending on a chip set (platform). In an example of the information processing apparatus as shown in FIG. 1, the host bridge 12 includes the memory controller 120. In the host bridge 12, the settings of the CPU 11 are performed. The memory controller 120 controls the memory 13 to set an operation clock or an operation timing of the memory 13.

The memory 13 is a main storage unit in the information processing apparatus. The memory 13 includes an SPD (Serial Presence Detect) 130. The SPD 130 is a ROM which stores information such as a kind and specification of memory chips mounted on a memory module (hereinafter referred to as memory information). For example, in the case that a clock rate, which is settable or usable as an operation clock of the memory, is decided or predetermined by a memory vendor, such information is recorded in the SPD 130.

The I/O bridge 14 is a chip connecting the I/O device. The I/O bridge 14 includes a CMOS (Complementary Metal Oxide Semiconductor device) 140. The CMOS 140 is a memory which can store information. Instead of the CMOS 140, a non-volatile memory such as a flash ROM may store information.

The graphic unit 15 is means having a display function.

The BIOS (Basic Input/Output System) ROM 16 is a ROM storing a BIOS 160, which is a control program for a basic input/output system for setting and controlling the hardware. The BIOS 160 has a memory clock setting function 161.

The clock generator 17 is means for generating the clock. A bus clock 170 is a clock outputted from the clock generator 17, and inputted into a chip set. The host bridge 12 and the I/O bridge 14 are called the chip set. The memory clock 171 is an operation clock of the memory 13. A clock inputted from the clock generator 17 into the host bridge 12 is adjusted to a clock rate set as the operation clock of the memory 13 by the memory controller 120, and inputted into the memory 13.

The CPU bus 20 connects the CPU 11 and the host bridge 12. The memory bus 21 connects the memory controller 120 and each memory 13. The I/O bus 22 connects the I/O device and the host bridge 12. In the example of the information processing apparatus as shown in FIG. 1, the I/O bus 22a connects the host bridge 12 and the I/O bridge 14, and the I/O bus 22b connects the host bridge 12 and the graphic unit 15.

An LPC/SPI bus 23 is a bus connecting the BIOS ROM 16. Though an LPC (Low Pin Count) bus was conventionally in the main stream, it has been recently changing to an SPI (Serial Peripheral Interface) bus. An SM (System Management) bus 24 is one kind of bus connected to a device, and used for controlling the device or acquiring the device information. In the example of the information processing apparatus as shown in FIG. 1, the SM bus 24 is connected to the SPD 130 of each memory 13 to acquire memory information from each SPD 130.

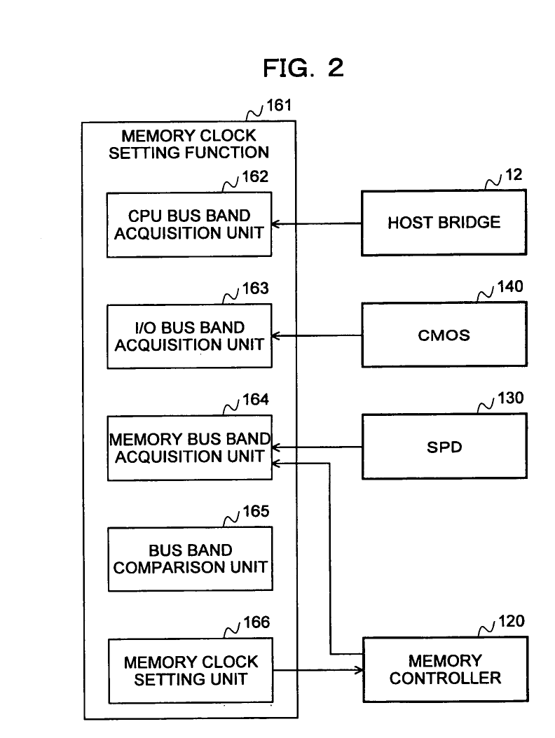

FIG. 2 is a diagram showing a configuration example of a memory clock setting function. The memory clock setting function 161 includes a CPU bus band acquisition unit 162, an I/O bus band acquisition unit 163, a memory bus band acquisition unit 164, a bus band comparison unit 165, and a memory clock setting unit 166.

The CPU bus band acquisition unit 162 acquires the CPU bus information set by the BIOS 160 from the host bridge 12, and calculates a CPU bus band. The CPU bus band depends on a kind of the CPU 11 mounted on the information processing apparatus. For example, when the CPU bus clock is 800 MHz and the data transfer amount per a clock is 8 bit, the CPU bus band is 800×8=6400 [Mb/sec].

The information of the I/O bus band is stored in advance in the CMOS 140 of the I/O bridge 14. The I/O bus band acquisition unit 163 acquires information of the I/O bus band from the CMOS 140. In the example of the information processing apparatus as shown in FIG. 1, information of two bands of the I/O bus 22a and the I/O bus 22b are acquired.

The memory bus band acquisition unit 164 acquires information of the memory bus 21 set by the BIOS 160 from the memory controller 120. Also, the memory bus band acquisition unit 164 acquires the memory information from the SPD 130 of each memory. The acquired memory information includes the setting information at each clock rate (for example, setting information at each clock rate of 800 MHz, 667 MHz and 533 MHz).

A theoretical value of the memory bus band is easily obtained from the operation clock of the memory 13 set in the memory controller 120. For example, when the set of the operation clock of the memory 13 is 800 MHz, the data transfer amount per a clock is 8 bit, and a dual channel is used, the theoretical value of the memory bus band is 800×8×2=12800 [Mb/sec].

The bus band comparison unit 165 compares the memory bus band, and a total band of the other buses connected to the memory controller 120 except for the memory bus 21. For example, in the example of the information processing apparatus as shown in FIG. 1, the total band of the CPU bus 20, the I/O bus 22a and the I/O bus 22b and the band of the memory bus 21 are compared.

The memory clock setting unit 166 sets the operation clock and operation timing of the memory 13 to the memory controller 120. When the total band of the other buses connected to the memory controller 120 except for the memory bus 21 is smaller than the memory bus band, a clock rate less than or equal to a clock rate of the current operation clock of the memory 13 is selected from among clock rates, which is settable as the operation clock of the memory 13, obtained from the memory information on the SPD 130. And, the clock rate is selected in a range where the memory bus band is not less than the total band of the other buses connected to the memory controller 120 except for the memory bus 21. Then, the selected clock rate is set as the operation clock of the memory 13 to the memory controller 120.

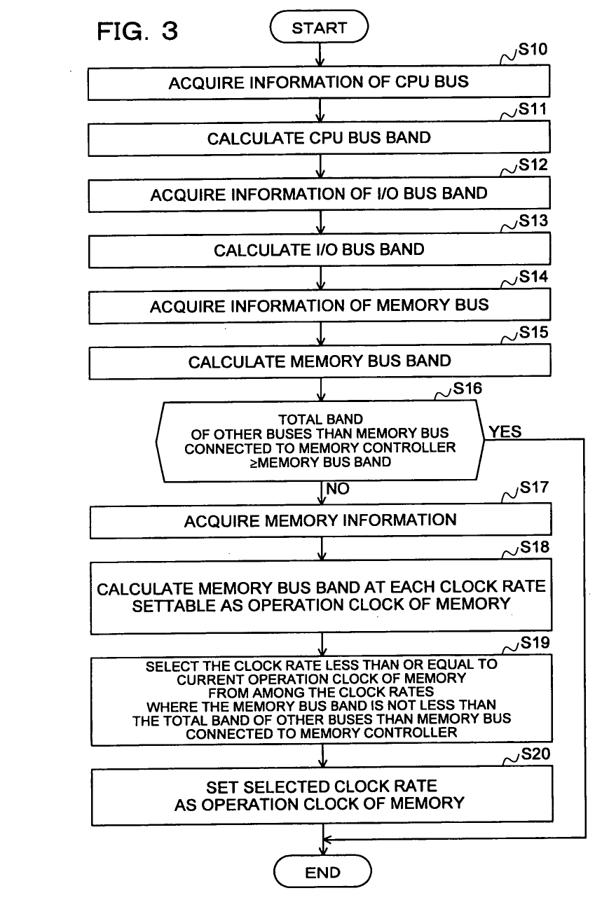

FIG. 3 is a flowchart of a memory clock setting processing performed by the memory clock setting function. When the power of the information processing apparatus is turned ON, and then the BIOS 160 is started. In the processing of the BIOS 160, the memory clock setting processing is performed by the memory clock setting function 161, as shown in an example of FIG. 3.

First, information on the CPU bus 20 is acquired (step S10), and the CPU bus band is calculated (step S11). Also, information on the I/O bus band is acquired (step S12), and the I/O bus band is calculated (step S13). The set information of the memory bus 21 is acquired (step S14), and the memory bus band is calculated (step S15).

The total band of the other buses (i.e., a total value of the CPU bus band and the I/O bus band), which is connected to the memory controller 120 except for the memory bus 21, and the memory bus band are compared (step S16). At this time, when the total band of the other buses, which are connected to the memory controller 120 except for the memory bus 21, is equal to or greater than the memory bus band, there is no need for changing the set of the operation clock of the memory.

When the total band of the other buses, which are connected to the memory controller 120 except for the memory bus 21, is smaller than the memory bus band at the step S16, the memory information is acquired (step S17), and the memory bus band obtained at each clock rate, which is settable as the operation clock of the memory 13, is calculated (step S18). The clock rate less than or equal to the current operation clock of the memory 13 is selected from among the clock rates, in which the memory bus band is not less than the total band of the other buses connected to the memory controller 120 except for the memory bus 21 (step S19). And, the selected clock rate is set as the operation clock of the memory 13 (step S20).

A specific example of this embodiment will be described below. In a system of the example as described below, it is assumed that the CPU bus band is 6400 Mb/sec and the I/O bus band is 4096 Mb/sec. Also, the mounted memory 13 has such specifications as 1 GB, DDR2, rated freq. of 800 MHz, and two device configuration (dual channel). Further, the operation clock of the memory can be set at four stages of 800 MHz, 667 MHz, 533 MHz, and 400 MHz. Furthermore, it is assumed here that the data transfer amount per a clock is 8 bit.

When the power of the information processing apparatus is turned ON, and the BIOS 160 is started. In the processing of the BIOS 160, the memory clock setting processing is performed by the memory clock setting function 161.

First, the total band of the other buses, which are connected to the memory controller 120 except for the memory bus 21, is calculated. Here, the CPU bus band and the I/O bus band are acquired, and their total is calculated as bellow.

6400 Mb/sec+4096 Mb/sec=10496 Mb/sec

Then, the memory bus band is obtained. Since the set of the operation clock of the memory 13 is 800 MHz, the data processed per a clock is 8 bit, the memory 13 comprising two devices is operated as the dual channel, the memory bus band is obtained as bellow.

800 MHz×8 bit×2 (dual channel)=12800 Mb/sec

The total band of the other buses, which are connected to the memory controller 120 except for the memory bus 21, and the memory bus band are compared as bellow.

10496 Mb/sec<12800 Mb/sec

Since the memory bus band is greater than the total band of the other buses except for the memory bus 21, it is checked whether or not there is the optimal clock rate as the other operation clock of the memory 13.

The memory bus band at each clock rate, which is settable set as the operation clock of the memory 13, is calculated as bellow.

800 MHz: 800 MHz×8 bit×2 (dual channel)=12800 Mb/sec

667 MHz: 667 MHz×8 bit×2 (dual channel)=106720 Mb/sec

533 MHz: 533 MHz×8 bit×2 (dual channel)=8528 Mb/sec

400 MHz: 400 MHz×8 bit×2 (dual channel)=6400 Mb/sec

The smallest clock rate among the clock rates for which the memory bus band is equal to or greater than the total band 10496 [Mb/sec] of the other buses, which are connected to the memory controller 120 except for the memory bus 21, is 667 MHz, at which the memory bus band is 10672 [Mb/sec].

Hence, the setting of the memory controller 120 is changed to decrease the operation clock of the memory 13 from 800 MHz to 667 MHz. Even when the operation clock of the memory 13 is decreased to 667 MHz, the memory data transfer rate is logically equivalent to the transfer rate at which the operation clock of the memory 13 is 800 MHz, since the memory bus band (10672 [Mb/sec]) is greater than the total band (10496 [Mb/sec]) of the other buses, which are connected to the memory controller 120 except for the memory bus 21.

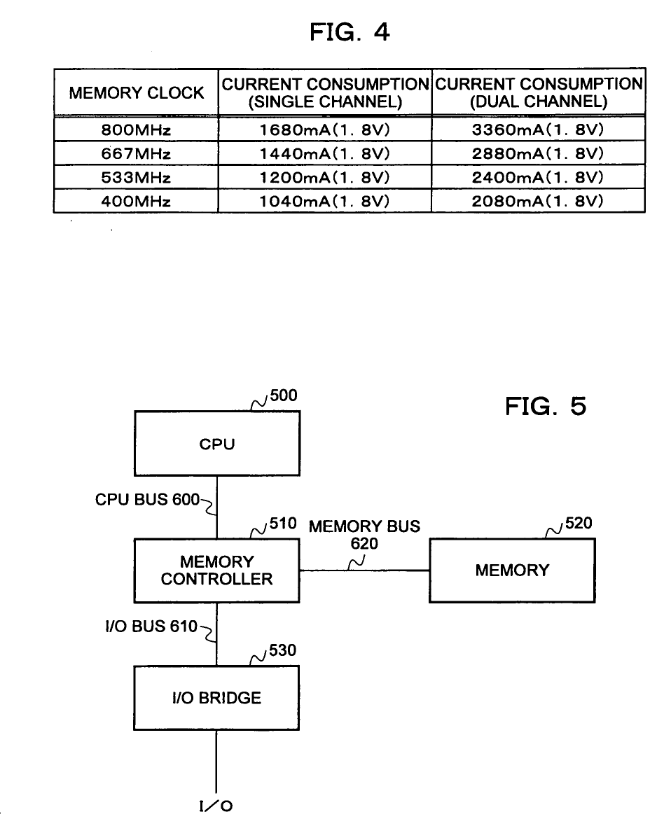

FIG. 4 is a view showing current consumption in reading memory data from a typical memory (1 GB, DDR2, rated freq. of 800 MHz). In FIG. 4, current consumption values at 667 MHz, 533 MHz and 400 MHz are values when the operation clock of the memory 13 is decreased from the rated freq. of rating 800 MHz.

In the case of rated freq. of 800 MHz and dual channel, the current consumption is 3360 mA (1.8 V), as shown in FIG. 4. When the clock rate is decreased to 667 MHz, the current consumption is 2880 mA (1.8 V). That is, when the clock rate of rated freq. of 800 MHz is decreased to 667 MHz, the current consumption is decreased by 480 mA (1.8 V).

The embodiments of the present invention have been described above. However, this invention is not limited to those embodiments. For example, it is not always required that the band information of each bus or information for calculating the band is acquired from where suggested in the embodiments. Since the band information of each bus or the information for calculating the band is possibly different depending on the platform of the information processing apparatus, it suffices that the necessary information is acquired according to the platform of the information processing apparatus to obtain the band of each bus.

Also, the data transfer amount per a clock and the number of channels (the number of devices comprising the memory) for use in calculating the memory bus band is not necessarily 8 bit and dual channel (memory comprising two devices). The memory band may be calculated using values according to the technique employed for the information processing apparatus.

What is claimed is:

1. An information processing apparatus having a memory, a memory controller controlling the memory, and a memory clock setting function for changing a set of an operation clock of the memory, the apparatus comprising:
a first acquiring unit acquiring a band of a memory bus connecting the memory controller and the memory;
a second acquiring unit acquiring a band of other buses connected to the memory controller except for the memory bus;
a comparing unit comparing a total band of the other buses connected to the memory controller except for the memory bus and the band of the memory bus; and
a changing unit changing, when the band of the memory bus is greater than the total band of the other buses connected to the memory controller except for the memory bus, the set of the operation clock of the memory by making the operation clock of the memory slower than current operation clock in a range where the band of the memory bus is not less than the total band of the other buses connected to the memory controller except for the memory bus.

2. The information processing apparatus according to claim 1, wherein the band of the memory bus is calculated based on a clock rate of the operation clock of the memory set in the memory controller or a clock rate settable as the operation clock of the memory.

3. A memory clock setting method in an information processing apparatus having a memory, a memory controller controlling the memory, and a memory clock setting function for changing a set of an operation clock of the memory, the method comprising:
acquiring a band of a memory bus connecting the memory controller and the memory;
acquiring a band of other buses connected to the memory controller except for the memory bus;
comparing a total band of the other buses connected to the memory controller except for the memory bus and the band of the memory bus; and
changing, when the band of the memory bus is greater than the total band of the other buses connected to the memory controller except for the memory bus, the set of the operation clock of the memory by making the operation clock of the memory slower than current operation clock in a range where the band of the memory bus is not less than the total band of the other buses connected to the memory controller except for the memory bus.

4. The memory clock setting method according to claim 3, wherein the band of the memory bus is calculated based on a clock rate of the operation clock of the memory set in the memory controller or a clock rate settable as the operation clock of the memory

5. The memory clock setting method according to claim 3, further comprising:
changing, when starting the information processing apparatus, the set of the operation clock of the memory by a control program of a basic input/output system stored in a basic input/output system storage memory provided for the information processing apparatus.
